(19) United States
(12) Patent Application Publication
(10) Pub. No.: US 2010/0010859 A1
(43) Pub. Date: Jan. 14, 2010

(54) METHOD AND SYSTEM FOR ALLOCATING DEPENDENT TASKS TO TEAMS THROUGH MULTI-VARIATE OPTIMIZATION

(75) Inventors: Krishna C. Ratakonda, Yorktown Heights, NY (US); Shankar Sadasivam, Urbana, IL (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/169,110

(22) Filed: Jul. 8, 2008

(51) Int. Cl. G06Q 10/00

(52) U.S. Cl. 705/9

(57) ABSTRACT

A method, system and article of manufacture are disclosed for allocating tasks to a team of persons. The method comprises comprising the step of identifying a set of tasks and a set of persons, each of the tasks having a given set of task attributes, and each of the persons having a given set of employee attributes. The method comprises the further steps of establishing a cost function including a set of cost factors based on one or more of the task or employee attributes, and establishing a utility function including a set of utility factors based on one or more of the task or employee attributes. One or more assignments of the tasks among the employees are found that minimizes the cost function; and the one assignment, of said one or more assignments, is identified that maximizes the utility function.

### BACKGROUND OF THE INVENTION

1. Field of the Invention

This invention generally relate to allocating tasks to teams, and more specifically, to allocating dependent tasks to teams through multi-variate optimization.

2. Background Art

The task of generating optimized schedules for employees or agents and other related resources has been known for years to be a complex one, and has spawned an entire industry of companies which provide products, of varying sophistication, which attempt to provide optimal resource scheduling. For instance, workforce management systems generally perform a common series of sequential tasks in order to accomplish the scheduling function. In a typical scenario, the first step of workforce management is to gather historical data, and these data are generally segregated by activities or skill.

Second, the data may be run through a forecasting engine to generate a forecast. The technique used to create the forecast can be one of a multitude of techniques known in the art, including but not limited to neural network forecasting, statistical forecasting, template-based forecasting, genetic algorithms and neural networks where the weighting functions are determined by genetic algorithms. The forecast is then used to generate a forecast of employee or agent resource demand, based on the forecast and the desired employee or agent occupancy rates.

Next, a scheduling engine, which takes into account a plurality of business rules concerning break policies, shift schedules, maximum and minimum workweeks, meal scheduling, and other related scheduling influences, creates an optimized overall schedule that includes specific work times for each employee or agent. Often agent preferences and vacation requests are included in this scheduling step. These scheduling engines 106, like the forecasting engines, use a plurality of well-known optimization techniques to generate a schedule which ensures that the expected workload is handled within established service level limits while meeting as many of the business rules and agent preference constraints as possible. Finally, during the period the schedule is in effect, an adherence monitor may be used to measure conformance to the schedule in real time, usually by integration of the workforce management system with one of the many interaction management engines known in the art.

The problem of allocation of tasks to teams is a well-studied problem where several constraints are set-up to ensure both fairness in shift assignment as well as improve efficiency (by reducing bench time). In the most straightforward setting, individual tasks are of similar scope and difficulty and the problem becomes one of schedule management with some constraints to ensure fairness. A typical example of this problem is scheduling the shifts of nurses in a hospital setting—the so-called Nurse scheduling problem. If the tasks have different skill capability requirements and the pool of available resources with appropriate skill sets is constrained, then the problem becomes a bit more complex and requires more advanced scheduling algorithms. An example of a typical shift scheduling algorithm implementation in practice can be found in Jannes Slomp and Nallan C. Suresh, “The shift team formation problem in multi-shift manufacturing operations”, European Journal of Operational Research Volume 165, Issue 3, 16 Sep. 2005, Pages 708-728.

### SUMMARY OF THE INVENTION

An object of this invention is to improve procedures for allocating tasks to teams.

Another object of the present invention is to balance a number of, sometimes conflicting, goals while scheduling tasks to teams.

A further object of the invention is to provide a comprehensive approach that tackles the workforce deployment problem in real time and that does not restrain any degree of freedom that can be potentially optimized.

These and other objectives are attained with a method, system and article of manufacture for allocating tasks to a team of persons. The method comprises comprising the step of identifying a set of tasks and a set of persons, each of the tasks having a given set of task attributes, and each of the persons having a given set of employee attributes. The method comprises the further steps of establishing a cost function including a set of cost factors based on one or more of the task or employee attributes, and establishing a utility function including a set of utility factors based on one or more of the task or employee attributes. One or more assignments of the tasks among the employees are found that minimizes the cost function; and the one assignment, of said one or more assignments, is identified that maximizes the utility function.

For example, the cost factors may include a first cost factor based on revenue that can be generated by completion of each task, a second cost factor based on a minimum acceptable skill level of a person who can be assigned to each task; and a third cost factor based on a number of hours required for an person, who satisfies the minimum acceptable skill level, to complete each task. Another cost factor may include a start time and an end time for each task.

In a preferred embodiment, the process of finding assignments among the persons that minimized the cost function is repeated at defined intervals, and the updating the utility function is updated at these defined intervals. In addition, at the end of each of these defined intervals, the method may be used to update a completion time for each task, the assignments of the tasks to the persons, and a fraction of completion of each task.

The preferred embodiment of the invention, described below in detail, is based on the principle that both tasks and resources are fungible, and this embodiment of the invention uses several constraints that are not typically part of a shift schedule or automated planning algorithm. Also, tasks themselves are dependent on each other and the objective function that needs to be optimized is comprised of multiple goals related to project success, quality and employee satisfaction. Balancing these (some times) conflicting goals while doing the scheduling is an important achievement of the present invention. By bringing together many of the variables, which are typically considered separately, into a joint optimization strategy, the invention can achieve a strategy that is closer to a globally optimal solution for this setting.

Given the above setting, a typical scenario may involve an organization handling a large number of projects (or tasks) and each project comprising of several smaller subtasks. These are usually not independent but generally connected via dependencies, resources, requirements, etc., and revenue at stake and more, which are listed below. Before task execution commences on big projects, it is conventional to have a certain well-defined schedule associated with executing all subtasks. For example, a project P comprising of subtasks P₁, P₂, P₃, . . . may have the following described schedule associated with it:

P₁-(P₂,P₃)-P₄-P₅-(P₆,P₇,P₈) . . .

Such schedules are typically obtained as the outputs of widely used project scheduling algorithms like PERT, critical path scheduling algorithm, etc., which take in as inputs the various subtasks and their dependencies, and produce as output the optimum start and stop times for each subtask, and an execution sequence of the entire project, as depicted above.

As the term is used herein, all subtasks may be referred to as just “tasks” and capture the fact that some of them are connected (might even belong to the same project indirectly via information about scheduling and dependencies.

The preferred embodiment of the invention addresses the realtime problem of assigning tasks to employees using the available information projects in queue and employee resources available in some sense that is optimal. Decision making of allocation to employees is done every time an employee becomes ‘available’ or when a new task is added to the queue. While this is the most optimal thing to do, it is quite possible that one can choose tasks or “available” employees to accumulate a bit before revisiting optimal task allocation. We can treat the (variable) time period between two decision making instants as a decision interval.

In the preferred embodiment of the invention addresses, a cost function that captures, at a minimum, the interplay of revenue, quality, scheduling and stability aspects of workforce management, is defined as optimality is defined via an assignment that minimizes the defined cost function. Defining the cost function will require a careful study of several factors that have an influence on how each of the individual effect weigh in the presence of the rest, i.e., the weights that one needs to assign to each of revenue, quality, scheduling, and stability terms of the cost function are assumed to be predetermined through an appropriate technique. These weights are not fixed, but one has the freedom to vary them with time, if current employee and data seem to require changes in the cost function behavior. A typical example would be when handling exceptions to the regular process/emergencies, where a certain task takes absolute precedence over the rest in which case one could tweak the weights in such a way that the cost function penalizes even small delays introduced in the execution of that task heavily.

This comprehensive approach, that tackles the workforce deployment problem real-time and does not restrain any degree of freedom that can be potentially optimized, can indeed help achieving an assignment with a better “utility value”. In particular, staying open to the option of reassigning employees while simultaneously maintaining a balance not to switch too often is found to be of help.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows a preferred procedure for implementing the present invention.

FIG. 2 is a block diagram of an exemplary computing environment in which this invention may be implemented.

### DETAILED DESCRIPTION OF THE PREFERRED EMBODIMENTS

The present invention, generally, provides a method, system and article of manufacture for allocating tasks to a team of persons. The method comprises the step of identifying a set of tasks and a set of persons, each of the tasks having a given set of task attributes, and each of the persons having a given set of employee attributes. The method comprises the further steps of establishing a cost function including a set of cost factors based on one or more of the task or employee attributes, and establishing a utility function including a set of utility factors based on one or more of the task or employee attributes. One or more assignments of the tasks among the employees are found that minimizes the cost function; and the one assignment, of said one or more assignments, is identified that maximizes the utility function.

The preferred embodiment of the invention is based on the principle that both tasks and resources are fungible, and this embodiment of the invention uses several constraints that are not typically part of a shift schedule or automated planning algorithm. Also, tasks themselves are dependent on each other and the objective function that needs to be optimized is comprised of multiple goals related to project success, quality and employee satisfaction. Balancing these (some times) conflicting goals while doing the scheduling is an important achievement of the present invention. By bringing together many of the variables, which are typically considered separately, into a joint optimization strategy the invention can achieve a strategy that is closer to a globally optimal solution for this setting.

Given the above setting, a typical scenario may involve an organization handling a large number of projects (or tasks) and each project comprising of several smaller subtasks. These are usually not independent but generally connected via dependencies, resources, requirements, etc., and revenue at stake and more, which are listed below. Before task execution commences on big projects, it is conventional to have a certain well-defined schedule associated with executing all subtasks. For example, a project P comprising of subtasks P₁, P₂, P₃, . . . may have the following described schedule associated with it:

P₁-(P₂,P₃)-P₄-P₅-(P₆,P₇,P₈) . . .

Such schedules are typically obtained as the outputs of widely used project scheduling algorithms like PERT critical path scheduling algorithm, etc., which take in as inputs the various subtasks and their dependencies, and produce as output the optimum start and stop times for each subtask, and an execution sequence of the entire project, as depicted above.

### Available Data

In accordance with the preferred embodiment of the invention, for each task awaiting employee assignment, we have the following information. A task identifier jεT type of the task tⱼεY minimum acceptable skill level of an employee who can be assigned this task vⱼεS, the potential revenue per unit time) that can be generated upon completion (of a unit-time equivalent of the task) rⱼεR⁺, and the number of hours required for a full time employee who satisfies the minimum skill level criterion to complete the task hⱼεR⁺, start time bⱼ and end time eⱼ, and a variable δⱼεε\{φ} which is set to a non-zero value for a task that is ‘continuing’ from the previous decision interval, or zero otherwise. The non-zero value chosen is the employee identifier of the employee to which the task was assigned in the previous decision interval. Also associated with each task is a dependency set Dⱼ that contains the list of tasks that will have to be executed before j. This set is updated with time and clearly, a task j can be assigned an employee only when Dⱼ={ }.

For each employee, we have the following information. An employee identifier iεε, employee salary costs which are typically constants and do not affect our optimization in any way, the set of tasks he can perform Tᵢ, and the employee skill level sᵢ.

### Optimization Problem

Given the above information (assume K>L), we seek a one-to-one assignment function f:T→ε, i.e., f maps iεT to an employee f(j)εε=f(j)=φ denotes a null employee assignment. The assignment is expected to satisfy the following constraints,

1. ∀j, s_{f(j)}≧vⱼ.

2. ∀j, tⱼεT_{f(j)}.

3. ∀j with Dⱼ≠{ }, f(j)=φ.

and minimizes the following cost function:

$$\underbrace{EmployeeCosts}_{= cons tant} - {\sum }_{j \text{:} f ( j ) \neq φ} {α}_{j} {r}_{j} - {\sum }_{j \text{:} f ( j ) \neq φ} {β}_{j} ( {s}_{f ( j )} - {v}_{j} ) + {\sum }_{j} {γ}_{j} {𝓁}_{j} ( {\hat{e}}_{j} - {e}_{j} ) + {\sum }_{j} {μ}_{j}^{〛} {\{ {δ}_{j} \neq 0 \}}^{〛} \{ f ( j ) \neq {δ}_{j} \} , \qquad ( 1 ) .$$

Where êⱼ is the expected completion time of task j under the current employee assignment. Equivalently, we may maximize the following utility function:

$${\sum }_{j \text{:} f ( j ) \neq φ} {α}_{j} {r}_{j} + {\sum }_{j \text{:} f ( j ) \neq φ} {β}_{j} ( {s}_{f ( j )} - {v}_{j} ) - {\sum }_{j} {γ}_{j} {𝓁}_{j} ( {\hat{e}}_{j} - {e}_{j} ) - {\sum }_{j} {μ}_{j}^{〛} {\{ {δ}_{j} \neq 0 \}}^{〛} \{ f ( j ) \neq {δ}_{j} \} , \qquad ( 2 ) .$$

Here, for all j, αⱼ, βⱼ, γⱼ, μⱼ are appropriate weighting factors that can change from one decision interval to another and address the aspects of overall project scheduling and customer satisfaction, and lⱼ(·) is a possibly nonlinear deterministic function which penalizes slipping of task completion schedules. The penalization term lⱼ(·) is assumed to have been constructed by taking into account that a deviation from normal project execution cycle will affect customer satisfaction negatively. The cost function in (2) corresponds to the cost incurred in the first unit time slot of any decision interval. Obviously, the first two terms, involving revenue and finance grow (linearly) with time over subsequent unit time slots and the last two terms, involving discontinuity and task scheduling will not have an influence until we arrive at the next decision making instant. Also, it may be noted that this is an example cost function. One can always use the same idea and construct variants to model the quality, schedule and stability terms in a different way. The cost function can also be potentially expanded, as the need may be to include other penalty or utility terms deemed necessary. This could include geographic constraints, employee task assignment flexibility and anything else that can be considered as ‘measurable’ within the framework of an ‘application factor’.

It is quite typical that in addition to the constraints listed above, one often encounters more constraints that are inspired by several factors like employee preferences, compatibility issues, geographic limitations, equitable distribution based on gender, race etc. and many more. It is possible to incorporate some of the above, but not all, into the cost function and constraints described above. E.g., the above formalization of the workforce management problem treats two employees who have similar attributes as fungible commodities, which, in reality, may not actually be the case. However, this is assumed to have been addressed when we see the problem in a factory-like setting where tasks have been already broken down into many small and easily repeatable subtasks, and where the nature of employees allows making such assumptions. A note on complexity: We search for an optimal assignment function f, with optimality defined as above. The total number of one-to-one functions (f:T→ε) that can exist is

$${P}_{\vert T \vert}^{\vert ɛ \vert} ,$$

assuming |T|≦
|ε| and

$${P}_{\vert ɛ \vert}^{\vert T \vert}$$

otherwise, where

$${P}_{r}^{n} = \frac{n !}{( n - r ) !} .$$

This is of course only an upper bound and the actual number of options to assigns tasks to employees is further limited by other constraints like skill level requirement etc.

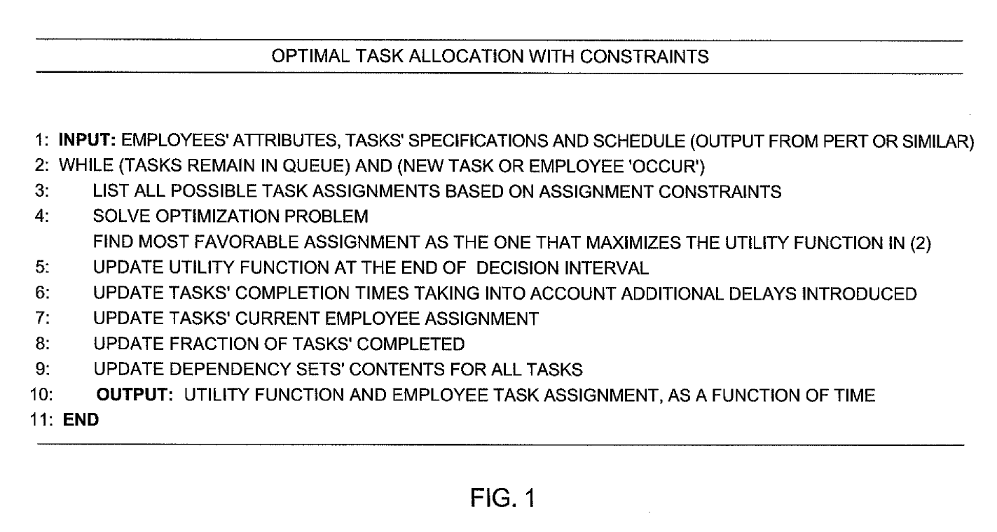

FIG. 1 illustrates a preferred procedure for implementing this invention. At step 1, data are obtained; and this data may include employee attributes, task specification, and schedule. As represented at 2, after the data are obtained, a number of steps are performed while tasks remain in queue and a new task or employee occurs. Specifically, step 3 is to list all possible task assignments based on assignment constraints. At step 4, the above-discussed optimization problem is solved, and the most favorable assignment is found as the one that maximizes the utility function (2).

Then, at steps 5 and 6, the utility function is updated at the end of the decision interval, and the tasks' completion times are updated, taking into account additional delays that may have been introduced. Steps 7 and 8 are to update the tasks' current employee assignment and the fraction of each tasks' completion. Step 9 is to update the dependency sets' contents for all tasks. At step 10, the utility function and employee task assignments are output as a function of time.

The preferred embodiment of the invention provides a comprehensive approach to the problem of workforce management and allows a user to take into account all possible factors that can possibly affect the overall taskforce assignment. It may be worthwhile to note that the notion of optimality defined is indeed strict, but for any modeling errors that may be introduced in the process of calculating the expected task completion times when introducing perturbations to the existing schedule. Another advantage would be that by using this approach, we would be able to get, directly or indirectly, answers to several questions that are often encountered in factory optimization related decision-making and equally often ignored or squashed by opting for easy sub optimal choices. These questions mainly pertain to finance, quality, scheduling, customer satisfaction, (which can be considered as a weighted combination of the rest) and may include the following:

1. Given a new task arrival, will it be beneficial to consider a shuffle in the current employee task assignment? If yes, what will be the incremental benefit offered by the ‘optimal’ choice over a more conventional but surely sub optimal choice?

2. Given the current workload, would it be a wise decision to add another employee? How does the cost function behavior change?

3. Over a specified time duration, what would be the optimality loss (in the sense of the utility function defined in (2)) in adopting some of the more commonly encountered workforce management algorithms as against the algorithm defined at the beginning of this section?

As discussed below, a few specific scenarios and how the cost function behaves and such. It suffices to restrict the discussion only to cases where the algorithm described at the beginning of this section tends to deviate from conventional workforce scheduling techniques. One scenario would be task reallocation from one employee to another. This typically involves a cost associated with the fact that we're introducing an undesirable discontinuity while the task is still getting executed (can be assumed to be fixed, or be made a function of difference in skill levels, or in the best case a function of both the task and the two employees involved), a loss or gain in the quality term depending upon the skill levels of the new and old employees to whom the task gets assigned, and also a possible loss or gain term caused by any new project that may get assigned to the ‘old’ employee (because of revenue, quality, schedule slipping etc.). Clearly, there are many competing cost functions to be considered and finding an optimal solution, for sure, is not trivial.

Another scenario would be when a task gets shelved while incomplete. In addition to whatever is discussed above, this would also involve an additional cost of introducing potential delays in task completion. These potential delays can be computed using already existing algorithms which can be considered as a derivative of PERT, critical path management etc., which when given as inputs the perturbations to start times we introduce in a normal project execution cycle, output the expected perturbations in the task completion times. Of course, by shelving a certain task, we do not know for sure by how much we are actually perturbing the normal project start times. However, one can always attempt at modeling this in many ways. Such a model should typically take care that into account the task arrival rates and any limits on shelving time of tasks etc.

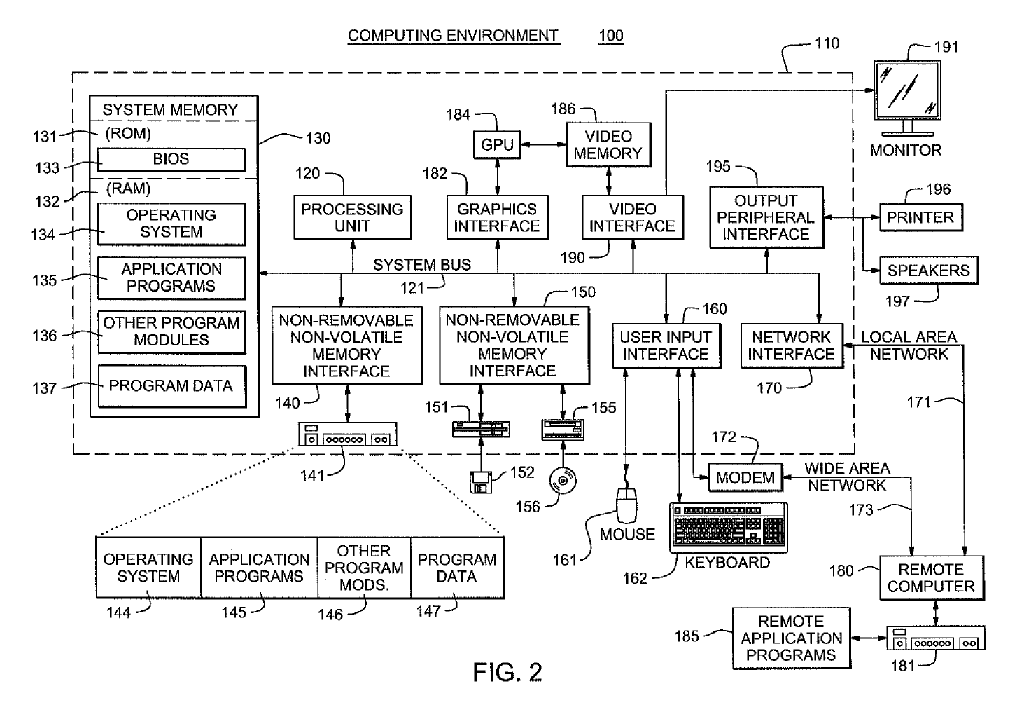

As an example, FIG. 2 and the following discussion provide a brief general description of a suitable computing environment in which the invention may be implemented. While a general-purpose computer is described below, this is but one example, the present invention may be implemented in an environment of networked hosted services in which very little or minimal client resources are implicated, e.g., a networked environment in which the client device serves merely as a browser or interface to the World Wide Web. It should also be understood that handheld, portable, and other computing devices of all kinds are contemplated for use in connection with the present invention.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations.

Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 2, thus, illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2, an exemplary system for implementing the invention includes a general purpose-computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and Wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 6 provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host-processing unit 120, and assumes responsibility for accelerated graphics port (AGP) communications. One or more graphics processing units (GPUs) 684 may communicate with graphics interface 182. In this regard, GPUs 184 generally include on-chip memory storage, such as register storage and GPUs 184 communicate with a video memory 186. GPUs 184, however, are but one example of a coprocessor and thus a variety of co-processing devices may be included in computer 110. A monitor 191 or other type of display device is also connected to the system bus 121 via an interface, such as a video interface 190, which may in turn communicate with video memory 186. In addition to monitor 691, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of allocating tasks to a team of persons, comprising the steps of:
identifying a set of tasks and a set of persons, each of the tasks having a given set of task attributes, and each of the persons having a given set of employee attributes;
establishing a cost function including a set of cost factors based on one or more of the task or employee attributes;
establishing a utility function including a set of utility factors based on one or more of the task or employee attributes;
finding one or more assignments of the tasks among the employees that minimizes the cost function; and
identifying the one assignment, of said one or more assignments, that maximizes the utility function.

2. A method according to claim 1, wherein said cost factors include a cost factor based on revenue that can be generated by completion of each task.

3. A method according to claim 1, wherein said cost factors include a cost factor based on a minimum acceptable skill level of a person who can be assigned to each task.

4. A method according to claim 1, wherein said cost factors include a cost factor based on a number of hours required for a person, who satisfies the minimum acceptable skill level, to complete each task

5. A method according to claim 1, wherein said cost factors include a geographic based cost factor.

6. A method according to claim 1, wherein said cost factors include a start time and an end time for each task.

7. A method according to claim 1, wherein:
the finding step is repeated at defined intervals; and
the step of establishing the utility function includes the step of updating the utility function at said defined intervals.

8. A method according to claim 7, comprising the further step of at the end of each of said defined intervals, updating a completion time for each task, updating the assignments of the tasks to the persons, and updating a fraction of completion of each task.

9. A method according to claim 8, wherein each task is associated with a dependency set D identifying all of the other tasks that have to be executed before said each task, and the step of finding one or more assignments of the tasks includes the step of only assigning any task to a person when all of the other tasks in the dependency set associated with said any task, are executed.

10. A method according to claim 1, wherein the finding step includes the step of listing all possible task assignments based on assignment constraints.

11. A method according to claim 1, wherein the cost function is:
$$\underbrace{EmployeeCosts}_{= constant} - {\sum }_{j \text{:} f ( j ) \neq φ} {α}_{j} {r}_{j} - {\sum }_{j \text{:} f ( j ) \neq φ} {β}_{j} ( {s}_{f ( j )} - {v}_{j} ) + {\sum }_{j} {γ}_{j} {𝓁}_{j} ( {\hat{e}}_{j} - {e}_{j} ) + {\sum }_{j} {μ}_{j}^{〛} {\{ {δ}_{j} \neq 0 \}}^{〛} \{ f ( j ) \neq {δ}_{j} \} , \qquad$$
a task identifier jεT type of the task tⱼεY minimum acceptable skill level of an employee who can be assigned this task vⱼεS, the potential revenue (per unit time) that can be generated upon completion (of a unit-time equivalent of the task) rⱼεR⁺, and the number of hours required for a full time employee who satisfies the minimum skill level criterion to complete the task hⱼεR⁺, start time by and end time eⱼ, and a variable δⱼεε\{φ} which is set to a non-zero value for a task that is ‘continuing’ from the previous decision interval, or zero otherwise.

12. A method according to claim 1, wherein the utility function is:
$${\sum }_{j \text{:} f ( j ) \neq φ} {α}_{j} {r}_{j} + {\sum }_{j \text{:} f ( j ) \neq φ} {β}_{j} ( {s}_{f ( j )} - {v}_{j} ) - {\sum }_{j} {γ}_{j} {𝓁}_{j} ( {\hat{e}}_{j} - {e}_{j} ) + {\sum }_{j} {μ}_{j}^{〛} {\{ {δ}_{j} \neq 0 \}}^{〛} \{ f ( j ) \neq {δ}_{j} \} , \qquad$$
a task identifier jεT type of the task tⱼεY minimum acceptable skill level of an employee who can be assigned this task vⱼεS, the potential revenue (per unit time) that can be generated upon completion (of a unit-time equivalent of the task) rⱼεR⁺, and the number of hours required for a full time employee who satisfies the minimum skill level criterion to complete the task hⱼεR⁺, start time bⱼ and end time eⱼ, and a variable δⱼεε\{φ} which is set to a non-zero value for a task that is ‘continuing’ from the previous decision interval, or zero otherwise.

13. A system for allocating tasks to a team of persons, comprising one or more processing units configured for:
identifying a set of tasks and a set of persons, each of the tasks having a given set of task attributes, and each of the persons having a given set of employee attributes;
establishing a cost function including a set of cost factors based on one or more of the task or employee attributes;
establishing a utility function including a set of utility factors based on one or more of the task or employee attributes;
finding one or more assignments of the tasks among the employees that minimizes the cost function; and
identifying the one assignment, of said one or more assignments, that maximizes the utility function.

14. A system according to claim 13, wherein said cost factors include:
a first cost factor based on revenue that can be generated by completion of each task;
a second cost factor based on a minimum acceptable skill level of a person who can be assigned to each task; and
a third cost factor based on a number of hours required for a person, who satisfies the minimum acceptable skill level, to complete each task.

15. A system according to claim 14, wherein said cost factors further include a start time and an end time for each task.

16. A system according to claim 15, wherein the finding step is repeated at defined intervals, and the utility function is updated at said defined intervals.

17. An article of manufacture comprising:
at least one computer usable medium having computer readable program code logic to execute a machine instruction in a processing unit for allocating tasks to a team of persons, said computer readable program code logic, when executing, performing the following steps:
identifying a set of tasks and a set of persons, each of the tasks having a given set of task attributes, and each of the persons having a given set of employee attributes;
establishing a cost function including a set of cost factors based on one or more of the task or employee attributes;
establishing a utility function including a set of utility factors based on one or more of the task or employee attributes;
finding one or more assignments of the tasks among the employees that minimizes the cost function; and
identifying the one assignment, of said one or more assignments, that maximizes the utility function.

18. An article of manufacture according to claim 17, wherein said cost factors include:
a first cost factor based on revenue that can be generated by completion of each task;
a second cost factor based on a minimum acceptable skill level of a person who can be assigned to each task; and
a third cost factor based on a number of hours required for a person, who satisfies the minimum acceptable skill level, to complete each task.

19. An article of manufacture according to claim 18, comprising the further step of at the end of each of said defined intervals, updating a completion time for each task, updating the assignments of the tasks to the persons, and updating a fraction of completion of each task.

20. An article of manufacture according to claim 16, wherein each task is associated with a dependency set D identifying all of the other tasks that have to be executed before said each task, and the step of finding one or more assignments of the tasks includes the step of only assigning any task to a person when all of the other tasks in the dependency set associated with said any task, are executed.
